(19) United States
(12) Patent Application Publication
(10) Pub. No.: US 2012/0144247 A1
(43) Pub. Date: Jun. 7, 2012

(54) SYSTEM, APPARATUS AND METHOD FOR PROVIDING TRAINING THROUGH INCORPORATION OF METAPHORICAL EXPRESSIONS

(75) Inventors: Kimberly Ann Brown, Laurel, MD (US); Huguens Jean, Bowie, MD (US)

(73) Assignee: Amethyst Technologies, LLC

(21) Appl. No.: 13/311,062

(22) Filed: Dec. 5, 2011

Related U.S. Application Data
(60) Provisional application No. 61/419,805, filed on Dec. 3, 2010.

(51) Int. Cl. G06F 11/07; G06F 3/048; G06F 9/46

(52) U.S. Cl. 714/47.1; 718/100; 715/772; 714/E11.024

(57) ABSTRACT

A system, apparatus and method for providing training through incorporation of metaphorical expressions are provided. A method includes receiving selected user preferences via a computer. The method also includes displaying a story board based on the selected user preferences, where the display shows text and images and the computer simultaneously plays vocals. Further, the method includes prompting the user to perform a task. Where the user successfully completes the task, the method includes taking the user to a next task. If the user does not successfully complete the task, the method includes repeating the story board and prompting the user to attempt the task again until the task is successfully completed.

This application claims any benefit and priority of and to an earlier filed provisional application, filed Dec. 3, 2010, identified as Application No. 61/419,805.

### BACKGROUND OF THE INVENTION

1. Field of the Invention

The present invention relates to is system, apparatus and method for providing training. More specifically, the system, apparatus and method provide training by taking into account various information and data to form metaphorical expressions. The resulting software is a metaphor enhanced technical training environment where various technical tasks are transformed into extended metaphors, and those metaphors are used to provide a relational structure of technical instructions domain, and an analogous game-based metaphorical world of time, space, and the objects and relations that define them.

2. Description of Related Art

Currently, medical diagnostic training is based on written procedures. Implementation of such training in the rural environments of developing countries only has a limited success rate proportional in general to level of education and language comprehension ability of individuals in such areas. This success rate is directly proportional to the level of education and the language comprehension ability of individuals in such areas.

### BRIEF SUMMARY OF THE INVENTION

Certain aspects of the present invention may provide solutions to the problems and needs in the art that have not yet been fully solved by currently available methods of medical diagnostic training. For example, certain aspects of the present invention provide a system, apparatus and method for providing training through metaphorical expressions that take into account various information, including geographic and demographic information pertaining to a user in the performance of tasks.

According to an aspect of the present invention, a method includes receiving selected, user preferences via a computer or similar device. The method also includes displaying a story board based on the selected user preferences, where the display shows text and images, and the computer simultaneously plays vocals. Further, the method includes prompting the user to perform a task. Where the user successfully completes the task, the method includes taking the user to a next task. If the user does not successfully complete the task, the method includes repeating the story board and prompting the user to attempt the task again until the task is successfully completed.

According to a second aspect of the present invention a computer program embodied on a non-transitory computer-readable medium causes a computer to receive selected user preferences. The computer program also causes the computer to display a story board based on the selected user preferences, where the display shows text and images and the computer simultaneously plays vocals. Further, the computer program causes the computer to prompt the user to perform a task. Where the user successfully completes the task, the computer program causes the computer to take the user to a next task. If the user does not successfully complete the task, the computer program causes the computer to repeat the story board and prompt the user to attempt the task again until the task is successfully completed.

According to a third aspect of the present invention, an apparatus includes a visual display and a user input device. The apparatus is configured to receive selected user preferences via the user input device. The visual display is configured to display a story board based on the selected user preferences, where the visual display shows text and images and the apparatus simultaneously plays vocals via speakers. Additionally, the visual display is configured to prompt the user to perform a task. Where the user successfully completes the task, the apparatus is configured to take the user to a next task. If the user does not successfully complete the task, the apparatus is configured to repeat the story board and prompt the user to attempt the task again until the task is successfully completed.

The foregoing and other aspects and advantages of the invention are illustrative of those that can be achieved, by the various exemplary embodiments and are not intended to be exhaustive or limiting of the possible advantages which can be realized. Thus, these and other aspects and advantages of the various exemplary embodiments will be apparent from the description herein or can be learned from practicing the various exemplary embodiments, both as embodied herein or as modified in view of any variation which may be apparent to those skilled in the art.

### BRIEF DESCRIPTION OF THE DRAWINGS

In order that the advantages of certain aspects of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope the invention will be described and explained with additional specificity and detail through the use of the accompanying drawings, in which:

FIG. 1 is an architectural view of a computer system configured to run a training module, according to an embodiment of the present invention.

FIG. 2 is a flowchart diagram of a method for running a training module, according to an embodiment of the present invention.

FIG. 3 is a flowchart diagram of a method for developing medical diagnostic software, according to an embodiment of the present invention.

FIG. 4 is a flowchart diagram of a method for developing medical diagnostic software, according to an embodiment of the present invention.

FIGS. 5A-E are example schematic representations of screenshots associated with the method of, for example, FIG. 2.

FIG. 6 is a flowchart diagram of a method for running a training module, according to an embodiment of the present invention.

### DETAILED DESCRIPTION

Reference will now be made in detail to embodiments of the present invention, examples of which are illustrated in the accompanying drawings, Wherein like reference numerals refer to the like elements throughout. The embodiments are described below to explain the present invention by referring to the figures.

It will be readily understood that the components of various embodiments of the present invention, as generally described and illustrated in the figures herein, may be arranged and designed in a wide variety of different configurations. Thus, the following more detailed description of the embodiments of it system, apparatus and method of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. By non-limiting example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments, and the described features, structures, or characteristics may be combined in any suitable manner in one or more embodiments.

As used in this application, the terms “a”, “an” and “the” may refer to one or more than one of an item. The terms “and” and “or” may be used in the conjunctive or disjunctive sense and will generally be understood to be equivalent to “and/or”. For brevity and clarity, a particular quantity of an item may be described or shown while the actual quantity of the item may differ. Features from an embodiment may be combined with features of another.

As used in this application, the term “including” (or any of its various forms such as include) means “including but not limited to” or without limitation; whereas “consisting” (or any of its various forms such as consist) means limited to a particular group or subset.

As discussed in the background, medical diagnostic training based on conventional written procedures has a limited success rate when implemented in rural environments in developing countries. In many such areas, the level of education and the language comprehension ability of individuals are low, which contributes to the low success rate in medical diagnostic training based on written procedures. Further, comparability of clinical trial outcomes for diseases, including malaria, is often hampered due to varying endpoints employed in clinical trial design.

In many embodiments of the present invention, metaphorical expressions are used to create associations that cause an individual to comprehend training more effectively. The metaphorical expressions are incorporated with innate image schemas, voice, and text to assist in training non-English or semi-literate speakers to successfully perform various types of medical diagnostic testing, including malaria diagnostic testing. In many embodiments, the metaphor takes the form of images, but may also include sound, physical interaction through a haptic interface, physical motion by a device on which the training is implemented (including buzzing or vibrating), or any other suitable interaction with the user.

The metaphorical expressions may be implemented via a narrative metaphor engine capable of generating new candidate stories based on a set of instructions provided by users. The narrative metaphor engine may transform a set of instructions into a culturally adequate story. The narrative metaphor engine may keep a history of all of the metaphorical extensions used for past training modules and may present the user with a category of tasks. Once the user picks the correct category, the narrative metaphor engine may try to establish similarities between the task to be entered and the tasks that are already in the software library. Once the similarity parameters have been established, the user inputs the number of discrete steps in the instruction set. After entering a description of each step in proper order, the narrative metaphor engine's logic controller generates a candidate extended metaphor to explain the task. The user is then asked to provide feedback on the social correctness and technical adequacy of the story. If the user approves the story, the story is entered in the software library, and the story is used as a reference extended metaphor to explain the task.

Over time, the software may accumulate new training modules, and the metaphorical expressions may be used to develop the relational structure between technical instructions and as game-based metaphorical virtual world may be used to build an analogy engine. This engine may assist instructors with the creation of clever and adequate extended metaphors for training new tasks.

In some embodiments, a software application running on a handheld device (such as, by way of a non-limiting example, a cell phone) will improve information delivery in rural environments to promote diagnostic testing proficiency, treatment methods, and standardized clinical trials for diseases including malaria and diarrheal diseases. Standardization in diagnostics and treatment will result in positive outcomes for clinical trials in developing countries and promote vaccine and drug development for infectious diseases. Standardization of training methods will also help to mitigate failure in endpoint analysis and execution.

Image schemas are representative of perceptual experiences and form the basis of cognitive development, and cognitive linguistic theory describes the innateness aspect. Learning in this fashion is a function of memory rather than reasoning and is much of the reason that infants can discern gender, age, and state. Image schemas include the concepts of space, containment, existence, multiplicity, and force. In many embodiments, metaphorical expressions are developed based on training context, location, and cultural experience with the goal of delivering an inclusive, engaging, and stimulating experience for the target audience while promoting figurative thinking. Designing instructional software with metaphorical expressions, image schemas, text, and voice on an interactive platform will, inter alit, enhance technical training efficiency, promote retention, and provide a means to gauge comprehension.

An advantage of some embodiments of the present invention is the elimination, of paper. The elimination of paper improves healthcare access due to, inter the ease of connectivity to, inter alia, qualified professionals. Additionally, message boards may allow individuals to solve common problems. Such message boards may be multi-lingual and illustrated or coded for sound. Another advantage of same embodiments of the present invention is using training modules for healthcare delivery. Diagnostic methods may include microscopy, and Rapid Diagnostic Testing (RDT) may be used to promote testing proficiency. A further advantage of some embodiments of the present invention is improved management through superior quality control methodology, equipment recommendation, and clinical trial standardization, including endpoint standardization and failure rate estimation. An additional advantage of some embodiments of the present invention is improving the quality of care through standardization of treatment methods segregated from and for different individuals, including children, pregnant women, adults, patients with HIV, and related follow-up requirements. Another advantage of some embodiments of the present invention is lower cost due to a reduction in presumptive treatment and misdiagnosis and a reduction of paper systems.

Software developed by any method or implemented by any apparatus and system discussed herein may assist with facilitating successful clinical trials in rural areas such as Tanzania. By way of a non-limiting example, a scientific advisory board of infectious disease experts could be used to review and enhance information comprised from World Health Organization (WHO) recommendations. The software may cater to the developing world environment and may provide instruction into any language, including into English speakers with all text in English in some embodiments. The software may include illustrations of key steps in the form of bench aids for semi-literate people and non-English speakers. By way of a non-limiting example, an option for Swahili vocals may be incorporated into the design of the software to enhance applicability in certain areas of Africa.

Barcode technology may he used to catalog any document and form permitting a way to pass key information to a surveillance database. Systems could be adapted to provide interfacing via multiple vehicles or media, including portal, text, and auto-dialer tied to Voice Over Internet Protocol (VOW), Pictures of slides, test results, and other diagnostics may be passed via the software to a database. U.S. federal regulations, for example, including Health Insurance Portability and Accountability Act (HIPAA) regulations, may be preserved with the assignment of barcodes automatically preventing the transfer of patient data, Topic-specific message boards (Including malaria, HIV, and tuberculosis) may be provided by some embodiments of the software in multiple languages.

In implementations where the computer is a cell phone, development may focus on popular platforms and different operating systems, including iPHONE, ANDROID, and BLACKBERRY and those pending market penetration. Applications for these various platforms may be developed in parallel using corresponding Software Development Kits (SDKs) and programming languages while keeping functionality and interfaces similar. The cell phones running these operating systems are beneficial for running a training module in some embodiments due to their capabilities for providing graphics, audio, and video which extend beyond the basic capabilities of phones running generic platforms, including Java ME and BREW. A database engine, including Structured Query Language (SQL) or SQLite, may be used with the software in some embodiments since there is likely to be limited connectivity in some areas. Users may store information locally during connection downtimes and a server-side application may be implemented to allow for remote uploading and downloading of data when connectivity is present, including the use of Application Service Provider (ASP) modeling. In certain embodiments, additional. software enhancements may be implemented that allow for authorized administrators (including companies performing clinical trials, malaria-focused groups) to develop laboratory/project specific modules for clinical trials and special circumstances.

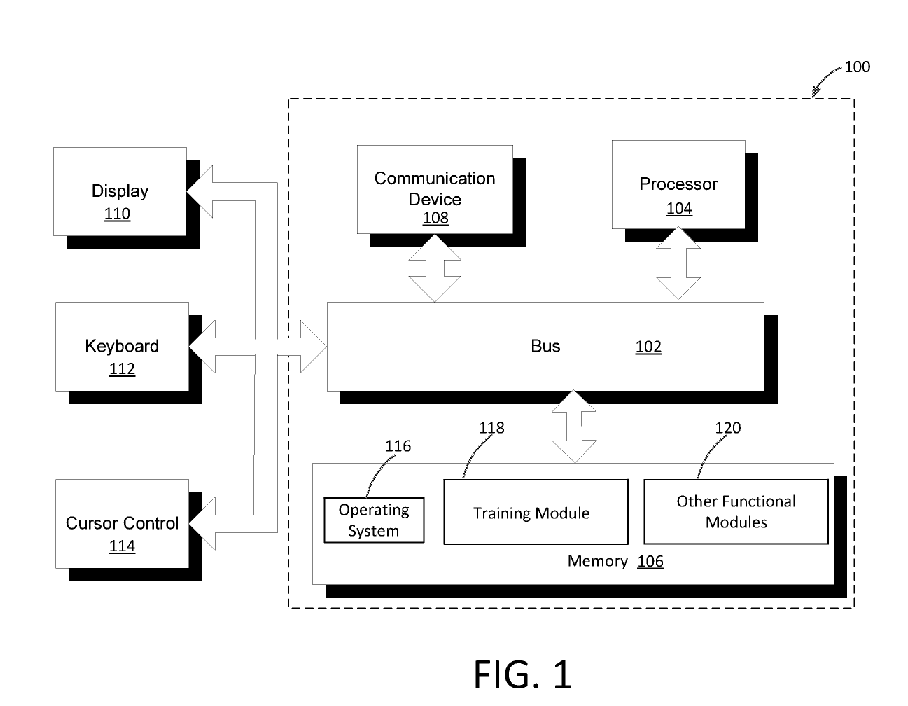

FIG. 1 is an architectural view of a computer 100 configured to run a training module 118, according to an embodiment of the present invention. Computer 100 includes a bus 102 or other communication mechanism for communicating information, and a processor 104 coupled to bus 102 for processing information. Processor 104 may be any type of general or specific purpose processor, including a central processing unit (“CPU”) or application specific in integrated circuit (“ASIC” Computer TOO further includes a memory 106 for storing information and instructions to be executed by processor 104. Memory 106 can be comprised of any combination of random access memory (“RAM”), read only memory (“ROM”), flash memory, cache, static storage including a magnetic or optical disk, or any other type of non-transitory computer readable media or combination thereof. Additionally, computer 100 includes a communication device 108, including a network interface card (wired, wireless or both), to provide access to a network. Therefore, a user may interface with computer 100 directly or remotely through a network or any other method, including linking to a repository or database.

Non-transitory computer readable media may be any available media that can be accessed by processor 104 and includes both volatile and nonvolatile media, removable and non-removable media, and communication media.. Communication media may include computer readable instructions, data structures, program modules or other data.

Processor 104 is further coupled via bus 102 to a display 110, by way of a non-limiting example, a Liquid Crystal Display (“LCD”), for displaying information to a user, by way of a non-limiting example, as computer status information. A keyboard 112 and a cursor control device 114, by way of a non-limiting example, a computer mouse, are further coupled to bus 102 to enable a user to interface with computer 100.

In accordance with an embodiment of the present invention, memory 106 stores software modules that provide functionality when executed by processor 104. The modules include an operating system 116 that provides operating system functionality for computer 100. The modules further include a training module 118 that is configured to facilitate cloning and synchronization of reports. Computer 100 can be part of a larger system as, by way of non-limiting example, a cluster computing system, a distributed computing system, a cloud computing system, a “server farm” or any other system having multiple computers and/or computers. Computer 100 will typically include one or more additional functional modules 120 to include additional functionality. In some embodiments, training module 118 may be part of operating system 116 or part of one or more other functional modules included in other functional modules 120.

In some embodiments, data used by training module 118 will be provided by a centralized data repository to enable rural environment users to receive current best practices. in certain embodiments, training module 118 will have consensus modules based, on standards, guidelines, or any other criteria set by any number of organizations, including the World Health Organization (WHO), the Center for Disease Control (CDC), the Foundation for innovative New Diagnostics (FIND), the United States Agency for international Development (USAID), and the Food and Drug Administration (FDA). Diagnostics, public health surveillance, and clinical trials may be enhanced by training module 118 with selectable topics including sampling profile, blood sampling, microscopy testing, RDT, storage, quality control, genotyping, treatment, prevention, equipment specifications, reference standards, message boards (in a number of different languages, by way of non-limiting example, including Swahili and English), and a surveillance database. The modules may be populated with items including standard operating procedures, bench aids (e.g., for malaria: specimen images, RDT results, and microscopy slide preparation), data collection forms, and databases. Functionality would include technology for at least real-time transfer of images of any item via any computer, with Said functionality significantly promoting healthcare and its access.

Many of the functional features described in this specification have been presented as modules in order to more particularly emphasize their implementation independence. By way of nonlimiting example, a module may be implemented as a hardware circuit comprising custom very large scale integration (“VLSI”) circuits or gate arrays, off-the-shelf semiconductors including logic chips, transistors, or other discrete components. A module may also be implemented in programmable hardware devices including field programmable gate arrays, programmable array logic, programmable logic devices or the like.

Modules may also be at least partially implemented in software for execution by various types or numbers of processors. An identified. unit of executable code in a software module may, by way of nonlimiting example, comprise one or more physical or logical blocks of computer instructions which may, by further non-limiting example, be organized as an object, procedure or function. Nevertheless, the executables of an identified module need not be physically located together, but may comprise disparate instructions stored in different locations that, when joined together, logically or otherwise, comprise the module and achieve the stated purpose for the module. Modules may be stored on a non-transitory computer-readable medium, which may be, by way of non-limiting example, a hard disk drive, a flash device, random access memory (“RAW”), a tape drive, an optical drive, a compact disk having read-only memory (“CD-ROM”) or a digital video disk having read-only memory (“DVD-ROM”), or any other such medium used to store data, The medium may be read-only or read write.

Indeed, by way of non-limiting example, a unit of executable code could be a single instruction, or many instructions, and may be distributed over several different code segments, among different programs, and across several memory devices. Similarly, operational data may be identified and illustrated herein within modules, and may be embodied in any suitable form and organized within any suitable type of data structure. The operational data may be collected as a single data set, or ma be distributed over different locations including over different storage devices, and may exist, at least partially, merely as electronic signals on a system or network.

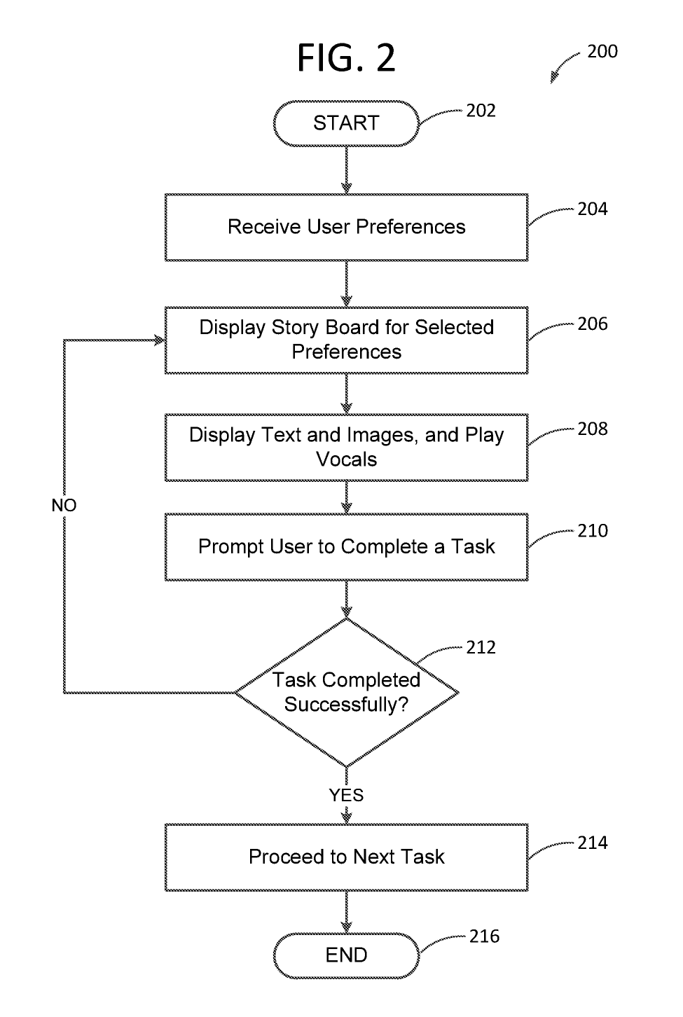

FIG. 2 is a flowchart diagram of a method 200 for running a training module, according to an embodiment of the present invention. In this embodiment, software presents a visual metaphorical story board in parallel with the written text that is verbalized by a computer, such as, by way of a non-limiting example, computer 100 of FIG. 1. The software may also cause the computer to react to a haptic interface and/or provide physical motion to the user in accordance with the story board.

In FIG. 2, the method 200 starts at 202. The user selects preferences that are received by the computer at 204. These preferences may include cultural preferences(including rural, cosmopolitan, geographical region, etc.) and a language selection, by way of non-limiting example. Next, the computer displays a story board based on the selected preferences at 206. This is the innate segment to which the user belongs due to the preferences. For instance, if the user specifies “rural” as describing his or her geographic location, the training module may display images associated with a rural environment, such as, by way of a non-limiting example, farm scenery. Words and images are displayed and vocals are played at 208. In some embodiments, the user will see the written, text in English, but the pictures and vocals will he in his or her language of choice. This is the conventional segment.

After the user has viewed the innate and conventional segments, the training module then causes the computer to prompt the user to perform a task at 210. The task may be, by way of non-limiting example, selecting the correct image on a touch screen interface of the computer. The training module then determines whether the task was completed successfully at 212. If the user was not successful, the innate and conventional segments are repeated until the user performs the task successfully.

In some aspects of the present invention, the software may track whether the user performed the task successfully at 212, as well as the number of errors that may have occurred. In this manner, a record of user errors may be developed during the execution of a task such that improvements on user performance for a given training module may be tracked. The software may adjust its quota for allowable errors based on the level of difficulty. Tasks may be considered to be successfully learned and completed when they are executed without errors. Keeping track of user errors and error frequency also allows the system to interactively emphasize part of the extended metaphor directly linked to those errors. This emphasized form of feedback may allow the user to concentrate on his/her weaknesses.

If the user successfully completed the task at 212, then the training module proceeds to the next task at 210 since the operation has ended at 216.

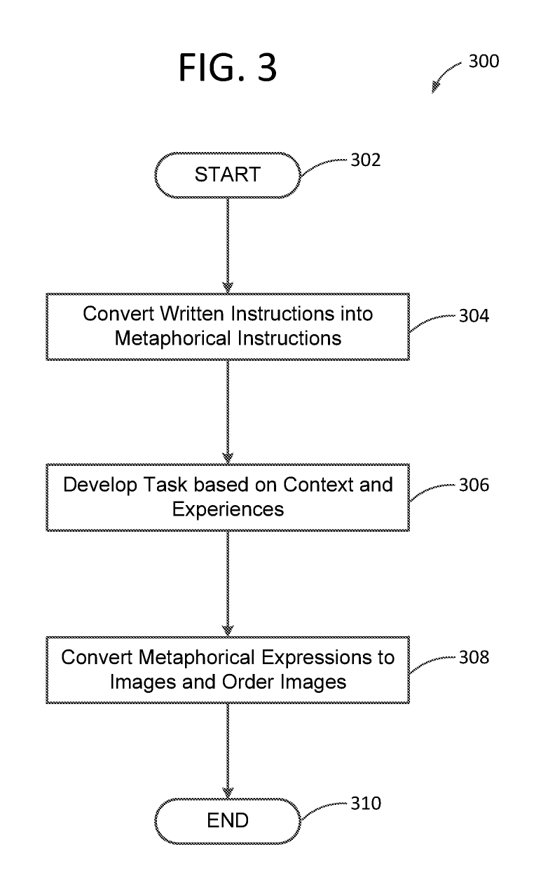

FIG. 3 is a flowchart diagram of a method 300 for developing medical diagnostic software, according to an embodiment of the present invention. In FIG. 3, the method 300 starts at 302. Medical diagnostic instructions, such as, by way of a non-limiting example, written malaria diagnostic instructions, are converted into metaphorical expressions at 304. In some embodiments, this conversion initially may be performed manually, but as more technical modules are developed, the metaphorical expressions may be correlated to the technical tasks with the intent of developing logic for drawing intelligent analogies to automatically transform instructions into metaphors. For instance, if a technical task is similar to, or matches, a description stored in a database, the software may suggest the stored description. If multiple potential matches occur, the software ma allow the user to select a metaphorical expression from a list.

The metaphorical expressions are developed based on the context of the task and information such as, by way of non-limiting example, location/cultural experiences at 306. By way of non-limiting example, as discussed above, a farming theme may be used for rural environments. Once the metaphorical expressions are developed, the metaphorical expressions are converted to a story board of pictures and ordered at 308. Image schemas deduced from the written instructions are also used to develop the story and pictures.

After the story is developed, the software is ready for use, and the operation may end at 310.

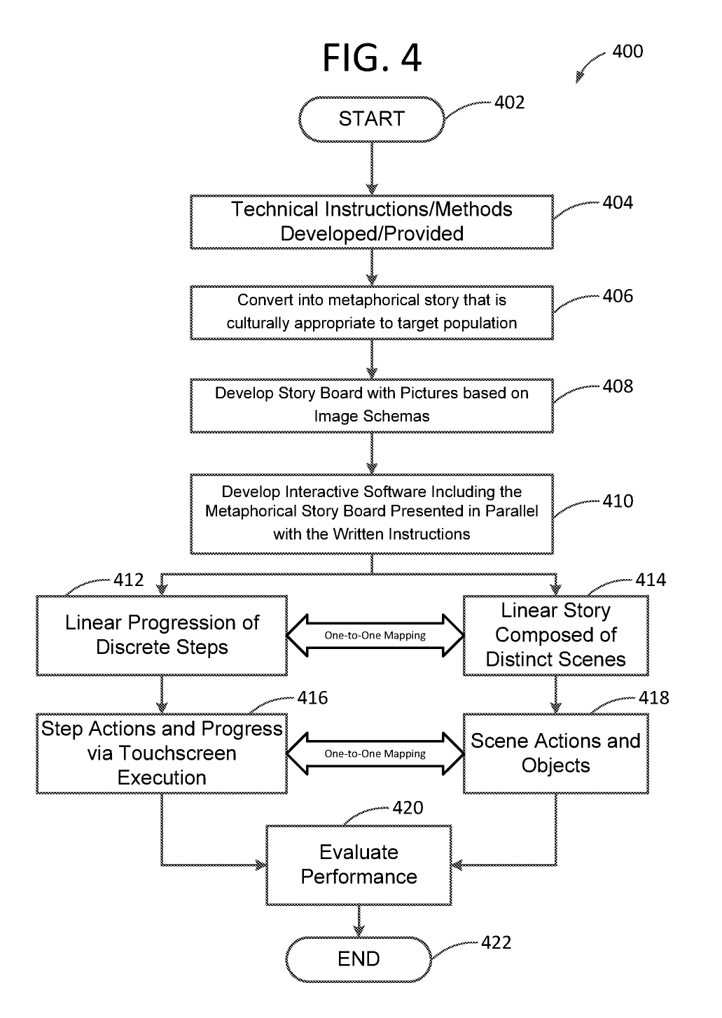

FIG. 4 is a flowchart diagram of a method 400 for developing medical diagnostic software, according to an embodiment of the present invention. In FIG. 4, the method 400 starts at 402. Technical instructions and methods are developed and provided at 404. These instructions and methods form the basis for the diagnostic testing. The technical instructions and methods are then converted into a metaphorical story that is culturally appropriate to the local population at 406. A story board is then developed with pictures based on image schemas at 408. Once the story board is in place, interactive software is developed at 410. The interactive software includes the metaphorical story board and is presented in parallel with written instructions.

A linear progression of discrete steps is presented to the user at 412. Simultaneously, a linear story composed of distinct scenes is presented at 414. As indicated by the arrow in FIG. 4, there is a one-to-one mapping between each discrete step and a corresponding distinct scene. Step actions and progress are made via a touch screen interface at 416. However, in some embodiments, a computer lacking a haptic interface may be used. Concurrently, scene actions and objects are presented at 418. There is a one-to-one mapping between each step action and corresponding scene actions and objects. Once the user completes a task, the user's performance is evaluated at 420. If the user fails due to too many errors, the user may be required to repeat the task until he or she passes.

After the user completes the training module, the method ends at 422.

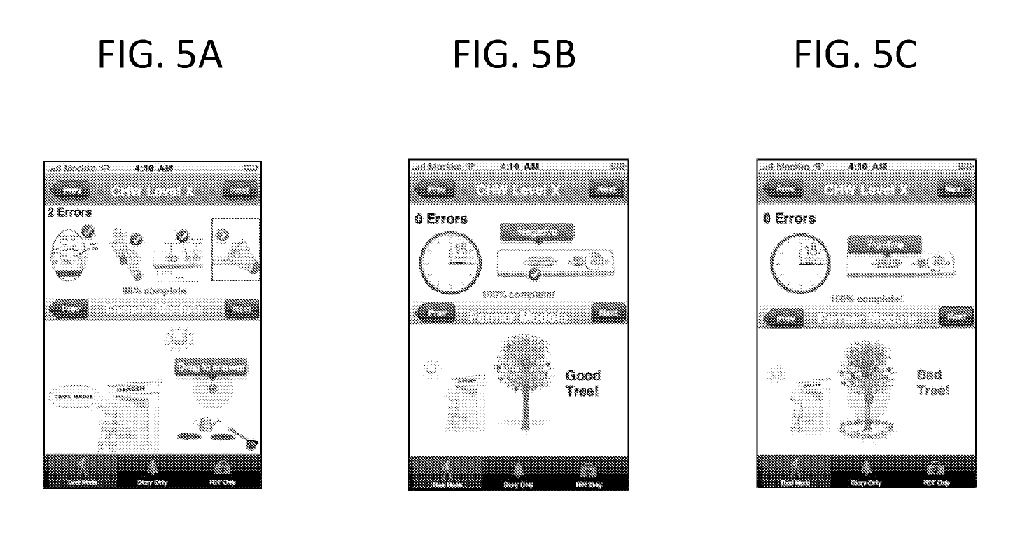

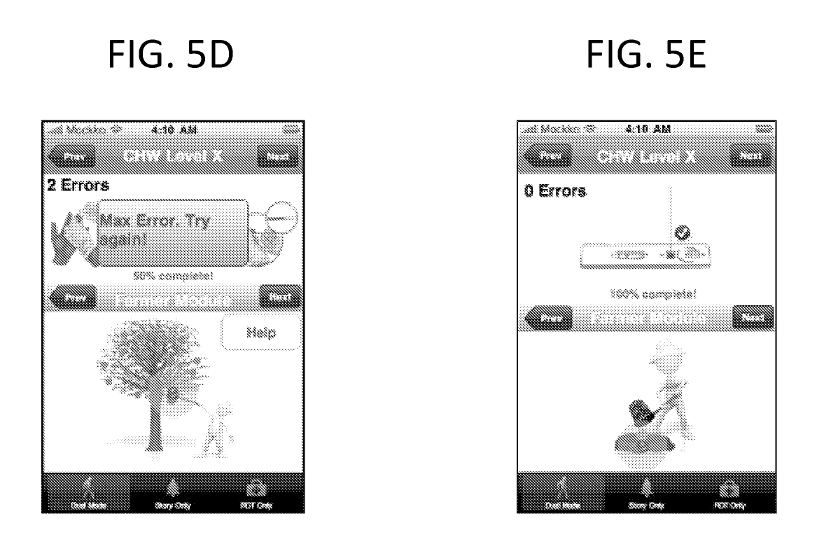

FIGS. 5A-E are example schematic representations of screenshots associated with the method of FIG. 2, illustrating the potential operation of a training module, according to an embodiment of the present invention. FIG. 5A depicts the technical task screenshot shown in parallel with the story board illustrating the metaphorical expression for the performance of a medical test. The technical tasks required for medical testing are directly correlated to story scenarios. The training module provides a measure of proficiency via the requirement to simulate the performance of the task. The proficiency results are scored, and the number of errors is displayed as illustrated in FIGS. 5A and 5B. The results of the medical test are also metaphorically expressed in the story board as depicted in FIGS. 5B and 5C. The negative test result was expressed as a tree with good fruit, and the positive test result was correlated to a tree with thorns. Turning to FIG. 5D, the user has reached the maximum number of errors allowed and failed the task, alerting the user to repeat the sequence. Conversely, in FIG. 5E, the user has zero errors and has passed the task.

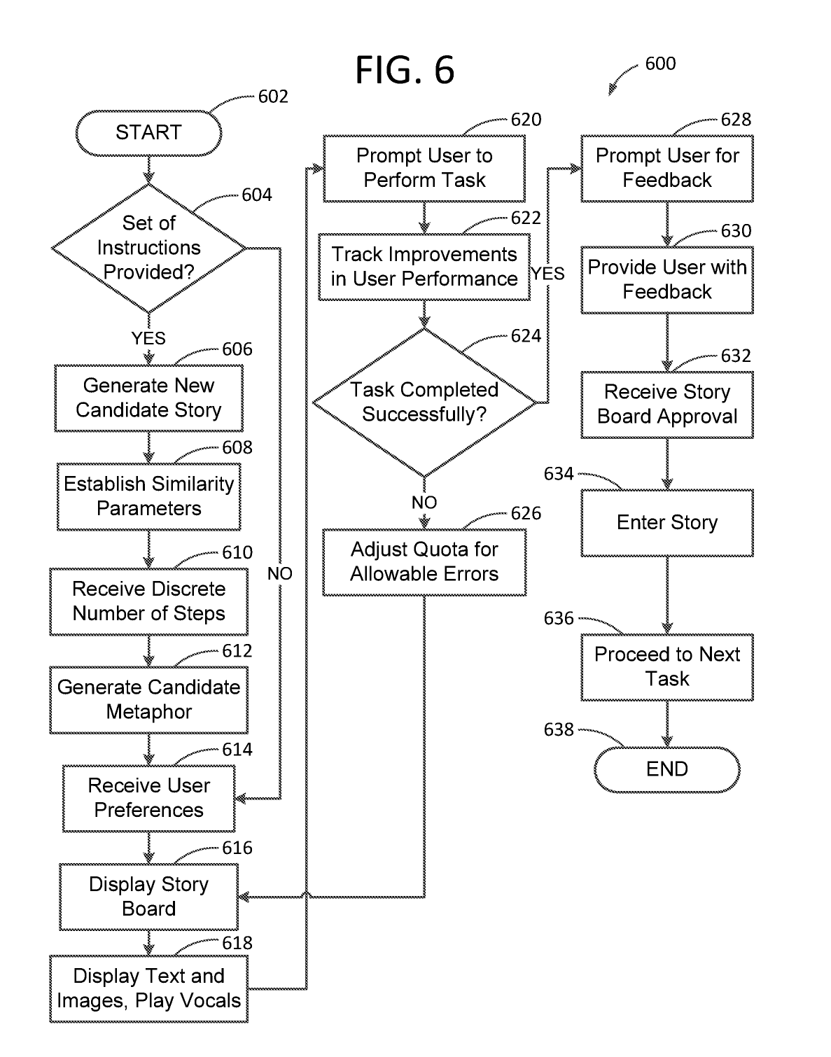

FIG. 6 is a flowchart diagram of a method 600 for running a training module, according to an embodiment of the present invention. The method may be implemented, by way of non-limiting example, by computer 100 of FIG. 1, for example. In FIG. 6, the method 600 starts at 602. If a set of instructions are provided by one or more users at 604, a new candidate story is generated at 606. Otherwise, the method proceeds to 614. Similarity parameters are established between the task to be entered and tasks that are already in a software library of metaphorical extensions used for past training modules at 608. A discrete number of steps is received in an instruction set from a user as an entry for the entered task at 610. A candidate metaphor is then generated to explain the entered task at 612.

Selected, user preferences are received at 614. A story board based on the selected user preferences is then displayed at 616. The display shows text and images, and the computer simultaneously plays vocals at 618.

The user is then prompted to perform the entered task at 620. Improvements in user performance on the entered task are tracked at 622. When the user does not successfully complete the entered task at 624, a quota for allowable errors is adjusted based on a level of difficulty determined from a record of user errors at 626 and the story board is repeated at 616. When the user successfully completes the entered task at 624, the user is prompted for feedback on the social correctness and technical adequacy of the story associated with the entered task at 628. The user is prompted to attempt the task again until the task is successfully completed.

The user is provided with feedback regarding specific errors and error frequency at 630. When user approval of the story is received at 632, the story is entered in the software library to be used as a reference extended metaphor to explain the entered task at 634. The method then proceeds to the next task at 636 and ends at 638.

The metaphorical diagnostic training systems, apparatuses and methods discussed herein assist a user to better remember and understand diagnostic techniques. The training takes into account information about the user, by way of a non-limiting example, location and language preference, and uses this information in concert with training context to create a more effective diagnostic training system. These techniques are especially beneficial in the developing countries.

Further, the diagnostic training systems, apparatuses and methods have a variety of applications, including those related to global health, combating malaria, bio-defense, disaster preparedness, and combat medical support training program development. The training may be especially effective for persons that have a cognitive inhibition due to language barrier, cultural barrier, depleted cognitive comprehension and traumatic brain injury (TBI). Training modules to accommodate varied medical diagnostic tests, hospital on-the-job and continuous education, combat support medical activities, military exercises, disaster response, and Science Technology Engineering and Mathematics (STEM) education may be developed.

According to an embodiment of the present invention, a method includes receiving selected user preferences via a computer. The method also includes displaying a story board based on the selected user preferences, where the display shows text and images and the computer simultaneously plays vocals. Further, the method includes prompting the user to perform a task. Where the user successfully completes the task, the method includes taking the user to the next task. If the user does not successfully complete the task, the method includes repeating the story board and prompting the user to attempt the task again until a successfully-completed task occurs.

In some embodiments, the selected preferences include cultural preferences and a language. In certain embodiments, the cultural preferences include the population density of the user's environment and the geographic region. In some embodiments, the text is in English while the images and vocals are in the user's native language. In certain embodiments, the user may interact physically with the computer via a haptic interface. In some embodiments, the computer may undertake physical motion as the story board progresses.

According to another embodiment of the present invention, a computer program embodied on a non-transitory computer-readable medium causes a computer to receive selected user preferences. The computer program also causes the computer to display a story board based on the selected user preferences, where the display shows text and images and the computer simultaneously plays vocals. Further, the computer program causes the computer to prompt the user to perform a task. Where the user successfully completes the task, the computer program causes the computer to take the user to the next task. If the user does not successfully complete the task, the computer program causes the computer to repeat the story board and prompt the user to attempt the task again until a successfully-completed task occurs.

According to yet another embodiment of the present invention, an apparatus includes a visual display and a user input device. The apparatus is configured to receive selected user preferences via the user input device. The visual display is configured to display a story board based on the selected user preferences, where the visual display shows text and images and the apparatus simultaneously plays vocals via speakers. Additionally, the visual display is configured to prompt the user to perform a task. Where the user successfully completes the task, the apparatus is configured to take the user to the next task. If the user does not successfully complete the task, the apparatus is configured to repeat the story board and prompt the user to attempt the task again until a successfully-completed task occurs.

Reference throughout this specification to any feature, advantage, or similar language does not imply that said feature, advantage, or language that may be realized with the present invention should be or is in any single embodiment of the invention. Rather, language referring to any feature and advantage is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will appreciate that the invention can be practiced without one or more of the specific features or advantages of a particular embodiment. In other instances, additional features and advantages may be recognized in certain embodiments that may not be present in all embodiments of the invention.

One having ordinary skill in the art will readily appreciate that the invention as discussed above may be practiced with steps in a different order, and with hardware elements in configurations which are different than those which are disclosed. Therefore, although the invention has been described based upon these preferred embodiments, one of skill in the art will appreciate that certain modifications, variations, and alternative constructions would be apparent, while remaining within the spirit and scope of the invention.

Although embodiments of the present invention have been shown and described, it would be appreciated by those skilled in the art that changes may be made in these embodiments without departing from the principles and spirit of the invention. By way of non-limiting example, while the term “computer” has been used in the description of some embodiments of the present invention, the invention may be applied to many types of computers. For purposes of the present invention, the term “computer” includes rack computing systems, cloud computing systems, distributed computing systems, personal computers, laptops, cell phones, personal digital assistants, tablet computers, handheld devices, mainframes, any networked devices that perform computing operations, or any other suitable instrument for achieving the goals of the invention. By way of a second non-limiting example, while the specification refers to the lack of the need for paper, one skilled in the art may appreciate that the method of FIG. 2, for example, could yield a real-time full audit trail derived from the continuous recordation of ever event routine or task as well as retroactive reporting of data to selected or remote databases. Accordingly, in view of the changes that may be made to the disclosed embodiments, the scope of the invention is defined in the claims and their equivalents and not limited to the embodiments shown and described.

What is claimed is:

1. A computer-implemented method, comprising:
receiving selected user preferences via a computer;
displaying a story board based on the selected user preferences, wherein the display shows text and images, and the computer simultaneously plays vocals;
prompting the user to perform a task;
when the user successfully completes the task, taking the user to a next task; and
when the user does not successfully complete the task, repeating the story board and prompting the user to attempt the task again until the task is successfully completed.

2. The computer-implemented method of claim 1, further comprising:
generating a new candidate story based on a set of instructions provided by one or more users.

3. The computer-implemented method of claim 2, further comprising:
keeping a history of the metaphorical extensions used for past training modules;
establishing similarity parameters between a task to be entered and tasks that are already in a software library;
receiving a discrete number of steps in an instruction set from a user as an entry for the entered task; and
generating a candidate metaphor to explain the entered task.

4. The computer-implemented method of claim 3, further comprising:
prompting the user for feedback on social correctness and technical adequacy of a story associated with the entered task; and
when user approval of the story is received, entering the story in the software library to be used as a reference extended metaphor to explain the entered task.

5. The computer-implemented method of claim 1, further comprising:
tracking improvements on user performance for a given training module by keeping a record of user errors during the task; and
adjusting a quota for allowable errors based on a level of difficulty determined from the record of user errors.

6. The computer-implemented method of claim 5, further comprising:
providing feedback to the user regarding specific errors and error frequency.

7. The computer-implemented method of claim 1, wherein the displayed story board is presented in parallel with written text that is verbalized by a computer executing the computer-implemented method.

8. The computer-implemented method of claim 1, wherein the selected user preferences include cultural preferences and a language selection constituting an innate segment and a conventional segment.

9. A computer program embodied on a non-transitory computer-readable medium, the program configured to control a computer to:
receive selected user preferences;
display a story board based on the selected user preferences, wherein the display shows text and images and the computer simultaneously plays vocals;
prompt the user to perform a task;
when the user successfully completes the task, take the user to a next task; and
when the user does not successfully complete the task, repeat the story board and prompt the user to attempt the task again until the task is successfully completed.

10. The computer program of claim 9, wherein the program is further configured to cause the processor to generate a new candidate story based on a set of instructions provided by one or more users.

11. The computer program of claim 10, wherein the program is further configured to cause the processor to:
keep a history of the metaphorical extensions used for past training modules;
establish similarity parameters between a task to be entered and tasks that are already in a software library;
receive a discrete number of steps in an instruction set from a user as an entry for the entered task; and
generate a candidate metaphor to explain the entered task.

12. The computer program of claim 11, wherein the program is further configured to cause the processor to:
prompt the user for feedback on social correctness and technical adequacy of a story associated with the entered task; and
when user approval of the story is received, enter the story in the software library to be used as a reference extended metaphor to explain the entered task.

13. The computer, program of claim 9, wherein the program is further configured to cause the processor to:
track improvements on user performance for a given training module by keeping a record of user errors during the task; and
adjust a quota for allowable errors based on a level of difficulty determined from the record of user errors.

14. The computer program of claim 13, wherein the program is further configured to cause the processor to provide feedback to the user regarding specific errors and error frequency.

15. An apparatus, comprising:
a visual display; and
a user input device, wherein
the apparatus is configured to receive selected user preferences via the user input device,
the visual display is configured to display a story board based on the selected user preferences, wherein the visual display shows text and images and the apparatus is configured to simultaneously play vocals via speakers,
the visual display is configured to prompt the user to perform a task,
when the user successfully completes the task, the apparatus is configured to take the user to a next task, and
when the user does not successfully complete the task, the apparatus is configured to repeat the story board and prompt the user to attempt the task again until the task is successfully completed.

16. The apparatus of claim 15, wherein the apparatus is further configured to generate a new candidate story based on a set of instructions provided by one or more users.

17. The apparatus of claim 16, wherein the apparatus is further configured to:
keep a history of the metaphorical extensions used for past training modules, establish similarity parameters between a task to be entered and tasks that are already in a software library,
receive a discrete number of steps in an instruction set from a user as an entry for the entered task, and
generate a candidate metaphor to explain the entered task.

18. The apparatus of claim 17, wherein the apparatus is further configured to:
prompt the user for feedback on social correctness and technical adequacy of a story associated with the entered task, and
when user approval of the story is received, enter the story in the software library to be used as a reference extended metaphor to explain the entered task.

19. The apparatus of claim 15, wherein the apparatus is further configured to:
track improvements on user performance for a given training module by keeping a record of user errors during the task, and
adjust a quota for allowable errors based on a level of difficulty determined from the record of user errors.

20. The apparatus of claim 19, wherein the apparatus is further configured to provide feedback to the user regarding specific errors and error frequency.
